(19) United States
(12) Patent Application Publication
(10) Pub. No.: US 2002/0097522 A1
(43) Pub. Date: Jul. 25, 2002

(54) Preamp pinout to accommodate multiple R/W head styles for flip chip HDD systems

(76) Inventors: Patrick M. Teterud, Plano, TX (US); Paul Emerson, Murphy, TX (US)

Correspondence Address: TEXAS INSTRUMENTS INCORPORATED, P O BOX 655474, M/S 3999, DALLAS, TX, 75265

(21) Appl. No.: 10/044,678

(22) Filed: Jan. 11, 2002

Related U.S. Application Data
(60) Provisional application No. 60/261,555, filed on Jan. 12, 2001.

(51) Int. Cl. G11B 5/127

(52) U.S. Cl. 360/110

(57) ABSTRACT

The present invention includes a communication circuit for a head including a first row of communication points positioned along at least one edge of the communication circuit and a second row of communication points positioned along at least one edge of the communication circuit and behind the first row with the communication circuit being connected to the head through the first and second rows of connection points.

### FIELD OF THE INVENTION

The present invention relates to integrated circuits and more particularly to integrated circuits used in conjunction with a data storage system having at least one magnetic disk.

### BACKGROUND OF THE INVENTION

Magnetic disk drives have read/write heads which are used for both writing data to magnetic disks and reading data from magnetic disks. During a write operation, a write signal is provided to a selected read/write head from a write control circuit. The write signal represents data to be encoded onto the magnetic disk. More particularly, the read/write head receives encoded digital data from a “channel” chip. The transitions of the signal received from the channel chip cause the write current flowing within the read/write head to reverse direction which in turn induces a flux reversal in the magnetized material of the medium.

During a read operation, the read/write head senses flux reversals from the magnetic disk. The flux reversals are encoded into the magnetic disk during write operation. Based on flux reversals, the read/write head provides a read signal to the read channel. The read circuit amplifies the read signal and the channel circuit recovers the data. The read circuit then provides the data to a magnetic disk controller for further processing.

Each magnetic disk in the disk drive has a corresponding read “head” and write “head”, usually adjacent to both surfaces of the disk. Thus when all sides of the disk are being utilized in the drive, there are N multiplied by 4 heads per stack where N equals the number of disks in the drive. These heads are connected to their appropriate preamp channel heads typically through a flex media. Depending upon the orientation of the electrical preamp heads, the polarity and ordering of the physical heads is limited once the preamp is in placed into the drive.

The means required to connect the electrical circuits of the preamp to the physical read and write heads adjacent to the disk is, again, typically accomplished using a flex, which is a flexible medium that permit electrical signals to pass through it. Typically a flex medium is used as a method for routing electrical signals in non-rigid environments that are logistically inadequate and impossible using typical circuit boards. The flex routing from the physical heads to the electrical preamp channels typically maintains a different physical layout for connecting a four-channel disk drive system than for an eight-channel disk drive system. Typically, the physical head locations combined with the fixed preamp channel ordering limits and require costly metal or all layer revision of the preamp to accommodate the switch between the four-channel and the eight-channel disk drive system. In addition, the customer may require a different preamp channel alignment and ordering within the context of a certain channel count drive. This requirement typically happens due to the developing and changing properties of the physical heads and/or the physical limitations in routing on the flex. The obvious disadvantage of making these metal and/or all layer revisions is that it is expensive and time-consuming. These detrimental disincentives speak for themselves. Thus, there is a need and advantage for a singlesolution that would enable the preamp to be electrically connected to the physical heads in multiple configurations.

### SUMMARY OF THE INVENTION

The present invention provides an electrical pin configuation that incorporates a physical layout of pins that help eliminate the need for metal or all layer revisions and accommodate the differences and changes between the eight and four channel designs. The proposed configuration accommodates most, if not all possible physical head orientations along with proper flex routing considerations.

### BRIEF DESCRIPTION OF THE DRAWINGS

FIG. 1 illustrates power routing on the flex with one central pin for each power supply.

FIG. 2 illustrates three different head connectorconfigurations.

FIG. 3 illustrates power routing on the flex with several pins available for each power supply.

FIG. 4 illustrates the preamp pin configuration with first routing capability.

FIG. 5 illustrates the preamp pin configuration with second routing capability.

FIG. 6 illustrates the preamp pin configuration with third routing capability.

FIG. 7 is a side view of a disk drive system.

FIG. 8 is a top view of the disk drive system.

### DETAILED DESCRIPTION OF THE PRESENT INVENTION

The following invention is described with reference to figures in which similar or the same numbers represent the same or similar elements. While the invention is described in terms for achieving the invention's objectives, it can be appreciated by those skilled in the art that variations may be accomplished in view of these teachings without deviation from the spirit or scope of the invention.

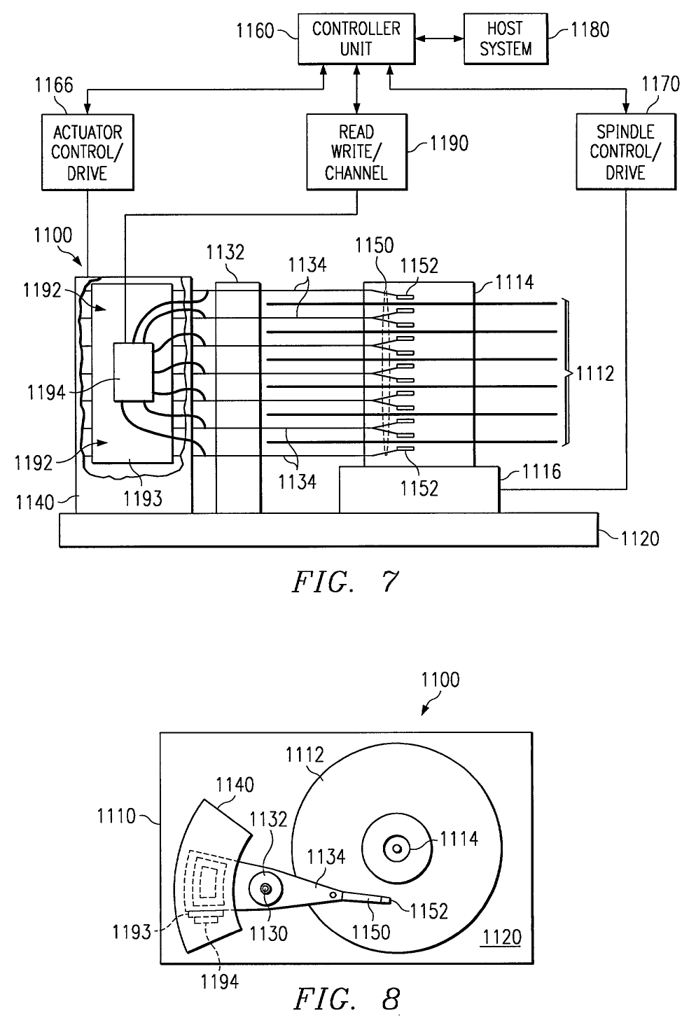

FIGS. 7 and 8 show a side and top view, respectively, of the disk drive system designated by the general reference 1100 within an enclosure 1110. The disk drive system 1100 includes a plurality of stacked magnetic recording disks 1112 mounted to a spindle 1114. The disks 1112 may be conventional particulate or thin film recording disk or, in other embodiments, they may be liquid-bearing disks. The spindle 1114 is attached to a spindle motor 1116 which rotates the spindle 1114 and disks 1112. A chassis 1120 is connected to the enclosure 1110, providing stable mechanical support for the disk drive system. The spindle motor 1116 and the actuator shaft 1130 are attached to the chassis 1120. A hub assembly 1132 rotates about the actuator shaft 130 and supports a plurality of actuator arms 1134. The stack of actuator arms 1134 is sometimes referred to as a “comb.” A rotary voice coil motor 1140 is attached to chassis 1120 and to a rear portion of the actuator arms 1134.

A plurality of head suspension assemblies 1150 are attached to the actuator arms 1134. A plurality of inductive transducer heads 1152 are attached respectively to the suspension assemblies 1150, each head 1152 including at least one inductive write element. In addition thereto, each head 1152 may also include an inductive read element or a MR (magneto-resistive) read element. The heads 1152 are positioned proximate to the disks 1112 by the suspension assemblies 1150 so that during operation, the heads are in electromagnetic communication with the disks 1112. The rotary voice coil motor 1140 rotates the actuator arms 1134 about the actuator shaft 1130 in order to move the head suspension assemblies 1150 to the desired radial position on disks 1112.

A controller unit 1160 provides overall control to the disk drive system 1100, including rotation control of the disks 1112 and position control of the heads 1152. The controller unit 1160 typically includes (not shown) a central processing unit (CPU), a memory unit and other digital circuitry, although it should be apparent that these aspects could also be enabled as hardware logic by one skilled in the computer arts. Controller unit 1160 is connected to the actuator control/drive unit 1166 which is in turn connected to the rotary voice coil motor 1140. A host system 1180, typically a computer system or personal computer (PC), is connected to the controller unit 1160. The host system 1180 may send digital data to the controller unit 1160 to be stored on the disks, or it may request that digital data at a specified location be read from the disks 1112 and sent back to the host system 1180. A read/write channel 1190 is coupled to receive and condition read and write signals generated by the controller unit 1160 and communicate them to an arm electronics (AE) unit shown generally at 1192 through a cut-away portion of the voice coil motor 1140. The AE unit 1192 includes a printed circuit board 1193, or a flexible carrier, mounted on the actuator arms 1134 or in close proximity thereto, and an AE module 1194 mounted on the connection circuit 1193 of the present invention or carrier that comprises circuitry preferably implemented in an integrated circuit (IC) chip including read drivers, write drivers, and associated control circuitry. The AE module 1194 is coupled via connections in the printed circuit board to the read/write channel 1190 and also to each read head and each write head in the plurality of heads 1152.

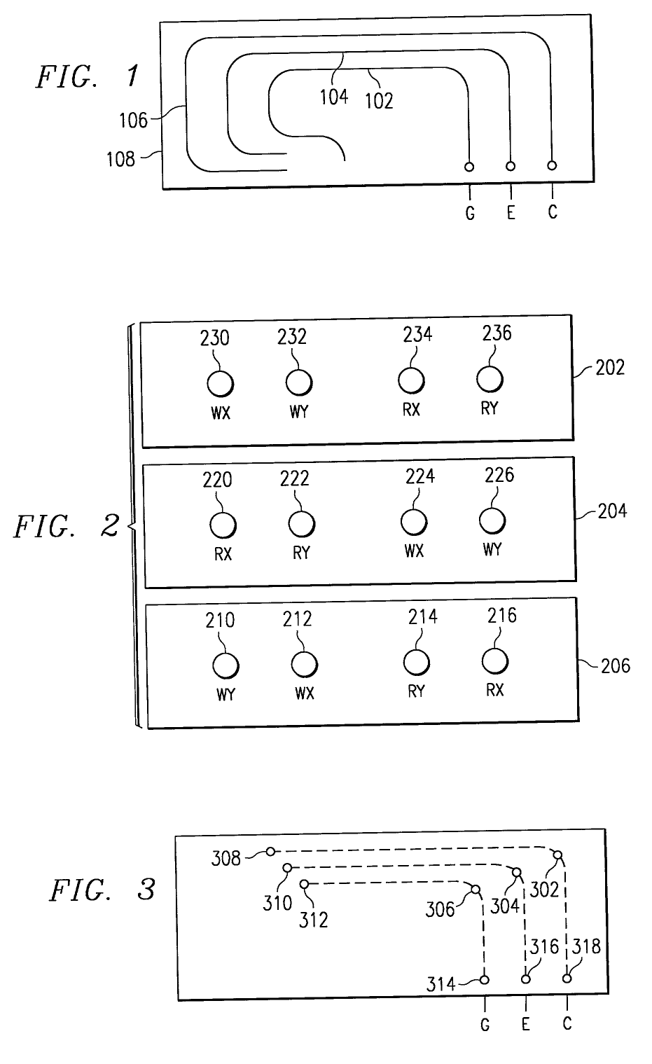

Turning now to FIG. 2, three possible head styles with their associated pin locationon the “flex”, which connects and interfaces to the physcial heads, are illustrated with their four heads named: WX, WY, RY and RX. First head style 202 has connection point 230 for signal WX, connection point 232 for signal WY, connection point 234 for signal RX and connection point 236 for signal RY.

Connection style 204 has connection point 220 for signal RX, connection point 222 for signal RY, connection point 224 for signal WX and connection point 226 for signal WY.

The third style 206 has connection point 210 for signal WX, connection point 212 for signal WY, connection point 214 for RY and connection point 216 for signal RX.

FIG. 4 illustrates a connection circuit with element 410 (where is 410? See side of FIG. 4), which includes the connection points for two channels, element 412 which includes the connection points for another two channels, and element 414 which includes connection points for four additional channels illustrating a total of eight channels. With the present invention, elements 410 and 412 could be left unconnected, being connected for a four-channel device. Element 410 could be unconnected, being connected for a six-channel device. Using element 414 as representative of all elements 410, 412 and 414, element 414 includes an outside row 420 and inside row 422 of connection points for the head. As illustrated in FIG. 4, the connection points for the read signals are in the outside row 420 and the connection points for the write signals are on the inside row 422. The reverse could work equally well. One channel would use connection point 430, connection point 432, connection point 434 and connection 436 for signals HRX, HRY, HWX and signal HWY respectively. Element 402 collectively illustrates control signals that are used for the preamp chip. Additionally, element 404 and element 406 control voltages such as ground and system supply. Additionally lines 440-447 illustrate one specific signal routing possibility on the flexfor style 202 as illustrated in FIG. 2. This signal routing is possible due to meeting spacing requirements. It should be understood that having outside row 420 and inside row 422 allows a connection for eight channels. However, if only four channels were required, then the connections for element 414 would be used, and the connections to elements 410 and 420 could be unused allowing flexibility and avoiding metal or layer changes.

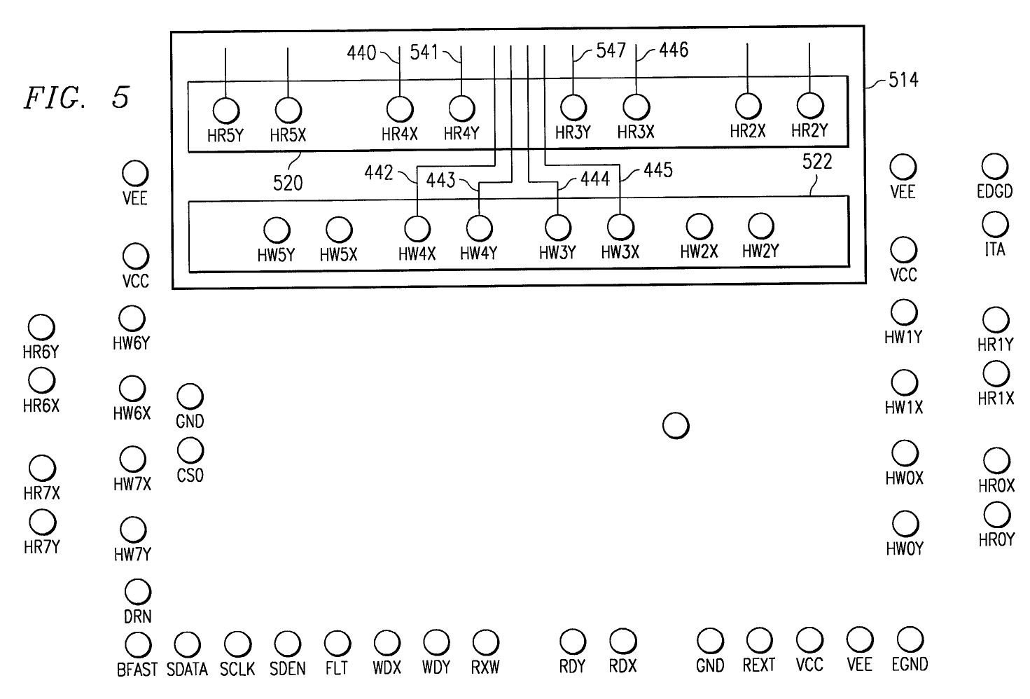

FIG. 5 illustrates the connection chip for connection with style 204. Outer row 420 and inner row 422 are the same as the outer row and inner row of FIG. 4. As illustrated, wire 440, wire 442, wire 443, wire 444 and wire 445 remain the same as found in FIG. 4. However, wire 541 has been changed to accommodate the new head style to route around wire 440. Likewise, wire 457 has been changed to accommodate the head style 204 to route around wire 406. This signal routing option is possible due to achieving appropriate spacing requirements.

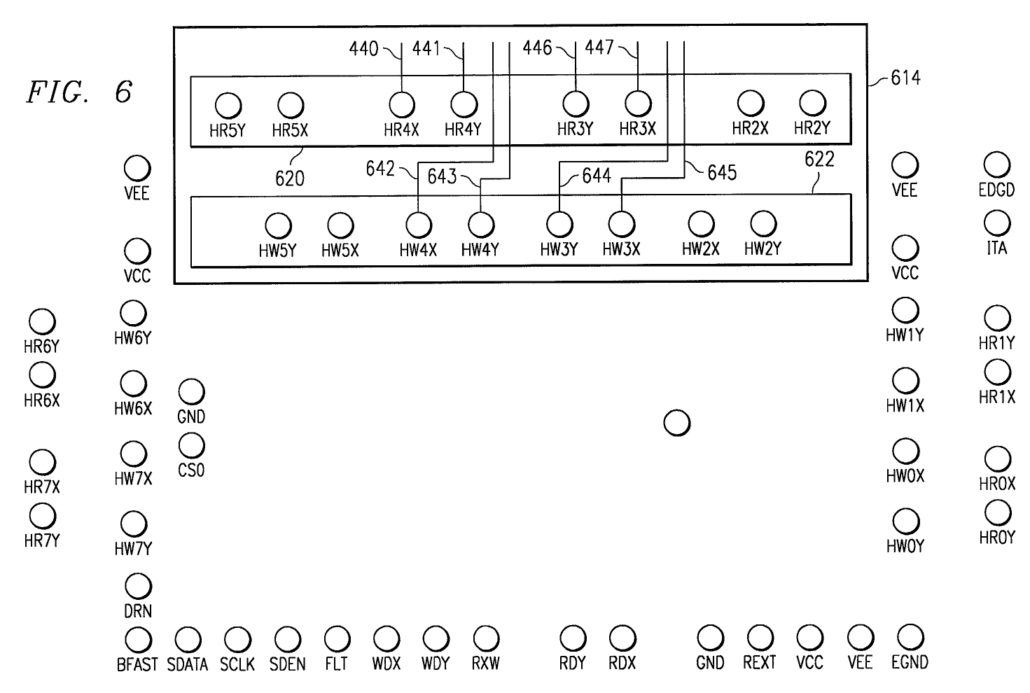

Turning now to FIG. 6, style 206 has been implemented. Wires 644 and 648 have been moved between wires 441 and 446 (see FIG. 4), and wires 644 and 645 have been moved to the left of wire 447. Element 614 corresponds to element 514 and element 414 of FIGS. 5 and 4 respectively. Likewise, outer row 620 and inner row 622 correspond to outer rows 520 and 420 and inner rows 522 and 422. By using inner and outer rows, a connection chip can be constructed to accommodate either eight-channel or four-channel without a redesign of the metals or layers. Again, this signal routing option is possible due to achieving appropriate spacing requirements. Additionally, different styles or configurations of the wires that are connected to the flex can be employed.

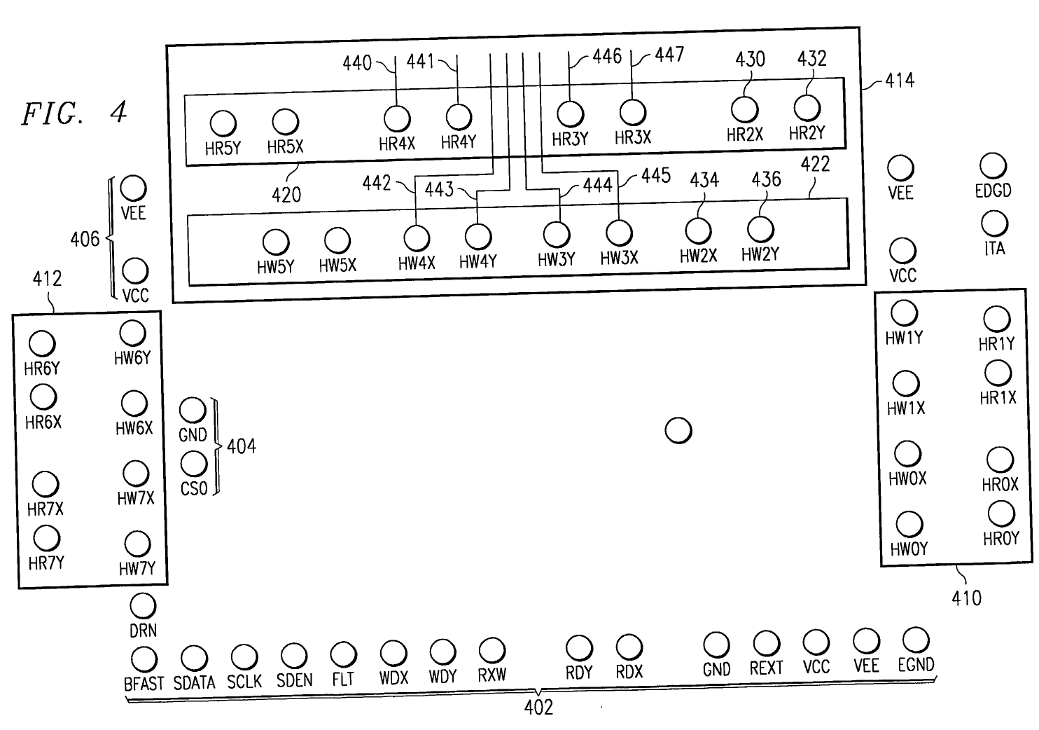

FIG. 3 illustrates a preamp chip having input power supply signals G, E and C. However, instead of one bump pad for each of these signals, each of these signals has multiple connection points on the connection chip. For example, signal G has a connection point at point 314, point 306 and a connection point at point 312. Signal E has a connection point at point 304 and a connection point at point 310 and point 316. Likewise, signal C has a connection points 302, 308 and 318. Thus, with multiple connection points, resistance can be reduced since the length of the signal, for example signal C, is reduced. The advantage here is less power supply voltage drop on the preamp and less power dissipation.

1. A communication circuit for a head comprising:
a first row of connection points positioned along at least one edge of said communication circuit;
a second row of connection points positioned along at least one edge of said communication circuit and behind said first row; and
said communication circuit being connected to said head through said first and second rows of connection points.

2. A communication circuit as in claim 1, wherein said first row of connection points is for a read operation of said head.

3. A communication circuit as in claim 1, wherein said second row of connection points is for a write operation of said head.

4. A communication circuit as in claim 1, wherein said first row of connection points is for a write operation of said head.

5. A communication circuit as in claim 1, wherein said second row of connection points is for a read operation of said head.

6. A communication circuit as in claim 1, wherein said first row and said second row extend along two sides of said communication circuit.
